(19) United States
(12) Patent Application Publication
(10) Pub. No.: US 2022/0411290 A1
(43) Pub. Date: Dec. 29, 2022

(54) PELLET MANUFACTURING APPARATUS AND WATER TREATMENT METHOD USING SAME

(71) Applicant: KOREA INSTITUTE OF INDUSTRIAL TECHNOLOGY, Cheonan-si, Chungcheongnam-do (KR)

(72) Inventors: Ju Dong LEE, Busan (KR); Chang Su JEON, Busan (KR); Seong Deok SEO, Busan (KR); Kyung Chan KANG, Busan (KR); Seung Min LEE, Gimhae-si, Gyeongsangnam-do (KR); Son Hai RUONG-LAM, Busan (KR)

(21) Appl. No.: 17/780,028

(22) PCT Filed: Jul. 7, 2020
(86) PCT No.: PCT/KR2020/008820

§ 371 Date: May 26, 2022

(30) Foreign Application Priority Data
Nov. 28, 2019 (KR) 10-2019-0155142

(51) Int. Cl. C02F 1/22; C02F 1/00

(52) U.S. Cl. CPC C02F 1/22; C02F 1/008; C02F 2209/02

(57) ABSTRACT

A pellet manufacturing apparatus according to the present invention includes: a reactor part for producing and discharging either gas hydrate slurry or ice slurry; a pellet forming part which is provided at one side of the outer portion of the reactor part, and which compresses the slurry discharged from the reactor part, so as to form the same into a pellet shape; and a control part for controlling the operation of the reactor part and the pellet forming part, wherein the control part controls the operation of a heating module so that the internal temperature of a first pipe is adjusted to be within a predetermined temperature range when the pellets are formed.

### TECHNICAL FIELD

The present invention relates to a pellet manufacturing apparatus and a water treatment method using the same, and more particularly, to a pellet manufacturing apparatus and a water treatment method using the same, which can manufacture high-purity gas hydrate pellets or ice pellets from gas hydrate slurry or ice slurry and can also effectively perform a treatment of high-concentration wastewater (or brine) or recovery of useful resources contained in target water to be treated using the pellets.

### BACKGROUND ART

Water treatment technologies such as seawater desalination, wastewater treatment, and recovery of useful resources contained in target water are technologies that can solve domestic and foreign problems of water shortage and environmental pollution and can secure alternative water resources, and thus it is a representative technology field for which an overseas markets can be developed and that can create high added value.

According to a study by the UK water research institute Global Water Intelligence (GWI), the size of the current global water market was estimated to reach about 500 trillion won as of 2010 and is expected to have grown by an average of 4.7% over the past five years to about 800 trillion won in 2020.

These water treatment technologies have been largely developed in the order of a first-generation technology using a physicochemical process, a second-generation technology using a biological process, and a third-generation technology using a membrane separation process, and recently, a membrane separation process that is environmentally friendly and has high water treatment efficiency has been mainly used.

However, even in the case of a membrane separation process such as a reverse osmosis membrane (RO) method, there is a problem in that energy consumption and high cost are required due to a complicated pretreatment process and frequent replacement of the reverse osmosis membrane, and also due to a limitation on a treatment capacity, there is a problem that a treatment of high-concentration industrial wastewater or salty seawater, which has become a problem in recent years, is not performed properly.

In order to solve the problems of the related art, a new type of water treatment technology using the principle of generating gas hydrate has been recently developed, and specific details thereof are disclosed in detail in [Document 1] and [Document 2] filed by the applicant of the present invention.

In the case of the water treatment technology using the principle of generating gas hydrates according to the following [Document 1] and [Document 2], compared to the conventional methods, process cost and energy consumption are relatively low and theoretical water treatment efficiency is also very high, and thus it is emerging as an alternative to the conventional membrane separation process.

However, in the case of water treatment technology using the existing principle of generating gas hydrate, since it is not easy to remove (that is, dehydrate) a filtrate contained in the gas hydrate produced in the form of slurry in a reactor and to remove the filtrate attached to a surface of the gas hydrate in which a dehydration process is completed, the actual water treatment efficiency is considerably lowered, and thus there is a problem that it is difficult to realistically replace the conventional membrane separation process despite the many advantages described above.

### DISCLOSURE

[Document 1] Korean Unexamined Patent Application, First Publication No. 2009-0122811 (published on Dec. 1, 2009)
[Document 2] Korean Patent No. 1652013 (issued on Aug. 23, 2016)

### Technical Problem

The present invention is directed to providing a pellet manufacturing apparatus and a water treatment method using the same, which can manufacture high-purity gas hydrate pellets or ice pellets by effectively removing a filtrate contained in slurry and a filtrate attached on a surface of the pellets in a process in which gas hydrate slurry or ice slurry produced in a reactor is formed into pellets.

Further, the present invention is also directed to providing a pellet manufacturing apparatus and a water treatment method using the same, which can improve production efficiency and homogeneity of the gas hydrate slurry or ice slurry produced in the reactor.

Further, the present invention is also directed to providing a pellet manufacturing apparatus and a water treatment method using the same, which can continuously manufacture gas hydrate pellets or ice pellets and can also maintain a constant hardness or thickness of the manufactured pellets.

Further, the present invention is also directed to providing a water treatment method which has remarkably excellent treatment efficiency for high-concentration industrial wastewater or brine using the above-described pellet manufacturing apparatus.

Further, the present invention is also directed to providing a water treatment method which can significantly improve the recovery efficiency of useful resources from industrial wastewater containing the useful resources using the above-described pellet manufacturing apparatus.

### Technical Solution

One aspect of the present invention provides a pellet manufacturing apparatus including a reactor part configured to produce and discharge slurry that is either gas hydrate slurry or ice slurry, a pellet forming part installed on one side of an outer portion of the reactor part and configured to compress the slurry discharged from the reactor part and to form the slurry into pellets, and a control part configured to control an operation of the reactor part and the pellet forming part, wherein the pellet forming part includes a first pipe having a through hole formed at one side of an outer surface thereof to be connected to an outlet of the reactor part, a compression forming module configured to compress the slurry supplied into the first pipe through the through hole and to form the slurry into pellets, and a heating module installed on one side of the first pipe to heat an inside of the first pipe, and the control part controls an operation of the heating module so that an internal temperature of the first pipe is adjusted to a predetermined temperature range when the pellets are formed.

Further, the heating module may include a second pipe configured to surround an outer surface of the first pipe in a jacket structure, and a heating medium supply module configured to cause a heating medium to flow to a space formed between the outer surface of the first pipe and an inner surface of the second pipe, and when the pellets are formed, the control part may control at least any one of a temperature of the heating medium or a flow amount of the heating medium to adjust the internal temperature of the first pipe.

Further, the compression forming module may include a piston installed inside the first pipe, and a driving cylinder configured to move the piston in a lengthwise direction of the first pipe.

Further, the piston may be configured of a first piston and a second piston, and the driving cylinder may be configured of a first driving cylinder installed at one end of the first pipe to move the first piston, and a second driving cylinder installed at the other end of the first pipe to move the second piston.

Further, the control part may move at least one of the first piston and the second piston a predetermined distance away from the other in a state in which ends of the first and second pistons are arranged at a position at which a through hole of the first pipe is formed, so that the slurry discharged from the reactor part is supplied to a space between the first and second pistons.

Further, the slurry may be supplied to a space between the first piston and the second piston, and the control part may control an operation of the first and second driving cylinders to compress the slurry by moving the first and second pistons closer to each other when the pellets are formed.

Further, the first driving cylinder and the second driving cylinder may be servomotor cylinders, and the control part may compress the slurry with a predetermined compressive force by controlling servomotor torque of the first and second driving cylinders when the pellets are formed.

Further, a plurality of dewatering holes may be further formed at a position spaced apart from the through hole in the outer surface of the first pipe, the slurry may be supplied to a space between the first piston and the second piston, and the control part may control an operation of the first and second driving cylinders to move the slurry to a position at which the dewatering holes are formed and then to compress the slurry when the pellets are formed.

Further, the pellet forming part may further include a third pipe interposed between the first pipe and the second pipe and configured to surround the outer surface of the first pipe in a jacket structure to cover the dewatering holes, and a drain tube connected to the third pipe so that a filtrate discharged to the third pipe through the dewatering holes during compression of the slurry is discharged to the outside or is re-supplied to the reactor part.

Further, the pellet forming part may further include a push cylinder installed on one side of an outer portion of the first pipe, an opening through which a cylinder rod of the push cylinder enters or exits and a pellet discharge hole configured to face the opening may be further formed at positions spaced apart from the through hole and the dewatering holes in the outer surface of the first pipe, and when forming of the pellets is completed, the control part may control operations of the first driving cylinder, the second driving cylinder, and the push cylinder to move the pellets to the position at which the opening and the pellet discharge hole are formed and then to discharge the pellets to the outside of the first pipe through the pellet discharge hole.

Another aspect of the present invention provides a pellet manufacturing method including a first step of producing slurry that is either gas hydrate slurry or ice slurry in a reactor, a second step of supplying the slurry produced in the first step into the first pipe installed on one side of an outer portion of the reactor, and a third step of compressing the slurry supplied in the second step inside the first pipe and forming the slurry into pellets, wherein, in the third step, an internal temperature of the first pipe is adjusted to a predetermined temperature range when the pellets are formed.

Further, in the third step, when the pellets are formed, a heating medium may flow in a space formed between an inner surface of a second pipe that surrounds an outer surface of a first pipe in a jacket structure and the outer surface of the first pipe, and at least one of a temperature of the heating medium or a flow amount of the heating medium may be controlled to adjust the internal temperature of the first pipe.

Further, a through hole through which the slurry is supplied may be formed in the outer surface of the first pipe, and the second step may include a step 2-1 of arranging ends of first and second pistons installed inside the first pipe at a position at which the through hole is formed, and a step 2-2 of moving at least one of a first piston and a second piston a predetermined distance away from the other in a lengthwise direction of the first pipe and thus supplying the slurry produced in the first step to a space between the first piston and the second piston through the through hole.

Further, in the second step, the slurry produced in the first step may be supplied to a space between a first piston and a second piston installed inside the first pipe, and in the third step, the slurry may be compressed by moving the first piston and the second piston closer to each other in a lengthwise direction of the first pipe when the pellets are formed.

Further, the first piston and the second piston may be moved by servomotor cylinders, and in the third step, servomotor torques of the servomotor cylinders may be controlled to compress the slurry with a predetermined compression force when the pellets are formed.

Further, a through hole through which the slurry is supplied and a dewatering hole through which a filtrate is discharged when the pellet is formed may be formed in an outer surface of the first pipe to be spaced apart from each other, in the second step, the slurry produced in the first step may be supplied to a space between the first piston and the second piston installed inside the first pipe through the through hole, and the third step may include a step 3-1 of moving the first piston and the second piston in the same direction along a lengthwise direction of the first pipe and thus moving the slurry supplied in the second step to a position at which the dewatering hole is formed, and a step 3-2 of moving the first piston and the second piston closer to each other in the lengthwise direction of the first pipe and compressing the slurry to form the slurry into pellets.

Further, the pellet manufacturing method may further include a fourth step of moving the pellets formed in the third step to a position of the pellet discharge hole formed in the outer surface of the first pipe and then discharging the pellets to the outside through the pellet discharge hole.

Still another aspect of the present invention provides a water treatment method of treating target water that is high concentration wastewater or brine, the method including a first step of supplying target water containing contaminants to a reactor and producing slurry that is either gas hydrate slurry or ice slurry, a second step of supplying the slurry produced in the first step into the first pipe installed on one side of an outer portion of the reactor, a third step of compressing the slurry supplied in the second step inside the first pipe to form the slurry into pellets and discharging the pellets, and a fourth step of dissociating or melding the pellets discharged in the third step and obtaining water from which the contaminants are removed, wherein, in the third step, an internal temperature of the first pipe is adjusted to a predetermined temperature range when the pellets are formed.

Yet another aspect of the present invention provides a water treatment method of recovering useful resources from target water, the method including a first step of supplying target water containing useful resources to a reactor and producing slurry that is either gas hydrate slurry or ice slurry, a second step of supplying the slurry produced in the first step into the first pipe installed on one side of an outer portion of the reactor, a third step of compressing the slurry supplied in the second step inside the first pipe to form the slurry into pellets and to discharge the pellets, and re-supplying a filtrate discharged during forming of the pellets to the reactor as the target water, a fourth step of measuring a concentration of useful resources contained in the target water in the reactor, and a fifth step of recovering the useful resources from the target water when the concentration measured in the fourth step is greater than or equal to a preset concentration, and repeating the first to fourth steps when the concentration is less than the preset concentration, wherein, in the third step, an internal temperature of the first pipe is adjusted to a predetermined temperature range when the pellets are formed.

Further, in the third step, the temperature range may be determined to include a temperature at which surfaces of the formed pellets are melted and contaminants attached to the surfaces of the pellets are discharged as a filtrate.

### Advantageous Effects

The pellet manufacturing apparatus and manufacturing method according to the present invention have an advantage that, since it is easy to maintain the temperature and pressure inside the reactor part in which the gas hydrate slurry is produced and the pellet forming part are spatially separated, gas hydrate production efficiency is improved.

Further, the pellet manufacturing apparatus and manufacturing method according to the present invention have an advantage that, since the internal temperature of the pellet forming part can be independently controlled by the heating medium supply module, high-purity pellets can be manufactured by dissolving a certain amount of the surface of the pellet during forming of the pellet and discharging contaminants attached to the surface of the pellet as a filtrate.

Further, the pellet manufacturing apparatus and manufacturing method according to the present invention have an advantage that, due to the configuration in which a fixed amount of suction and constant torque compression of the slurry are provided by a cylinder operated by a servo motor in the pellet forming part, the pellets can always be manufactured with a uniform thickness and/or hardness even when the pellets are repeatedly manufactured in a continuous process.

Further, the water treatment method according to the present invention has an advantage that, since it is possible to manufacture high-purity pellets from target water, the water treatment efficiency for high-concentration industrial wastewater or brine, or the recovery efficiency of the useful resources from the target water is very excellent.

### DESCRIPTION OF DRAWINGS

FIG. 1 is a perspective view for describing an overall configuration of a pellet manufacturing apparatus according to an embodiment of the present invention

FIG. 2 is a cross-sectional view along section A-A of FIG. 1.

FIG. 3 is an enlarged cross-sectional view of a reactor part shown in FIG. 2.

FIG. 4 is a view for describing a configuration of a scraper module shown in FIG. 2.

FIG. 5 is an enlarged cross-sectional view of a pellet forming part shown in FIG. 2.

FIG. 6 is a block diagram for describing an operation configuration of the apparatus of FIG. 1.

FIG. 7 is a view showing a process for manufacturing pellets by the apparatus of FIG. 1.

FIG. 8 is a view showing results of a comparative experiment on salt removal efficiency in the pellets manufactured by the apparatus of FIG. 1.

FIGS. 9 and 10 are process diagrams for describing water treatment methods using the pellet manufacturing apparatus and manufacturing method according to an embodiment of the present invention.

### MODES OF THE INVENTION

Hereinafter, exemplary embodiments of the present invention will be described in detail.

In the entire detailed description and claims of the specification, the term ‘slurry’ includes not only ‘gas hydrate slurry’ but also ‘ice slurry’ (also referred to as ‘slurry ice’).

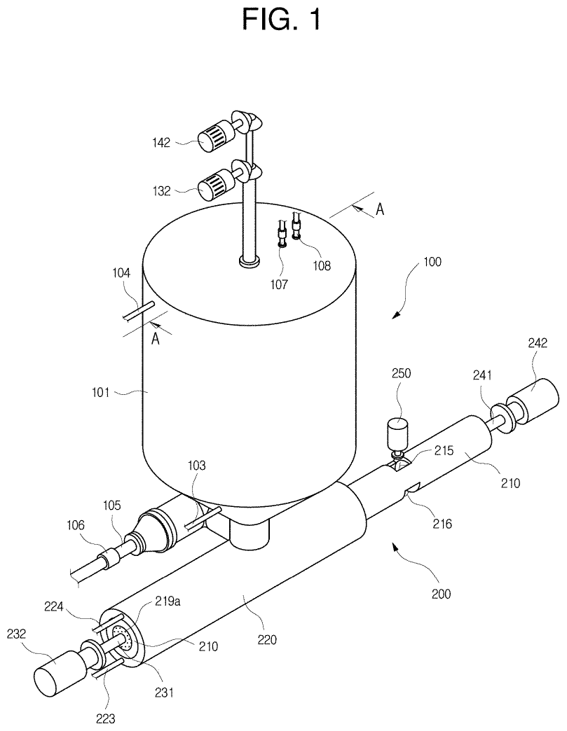

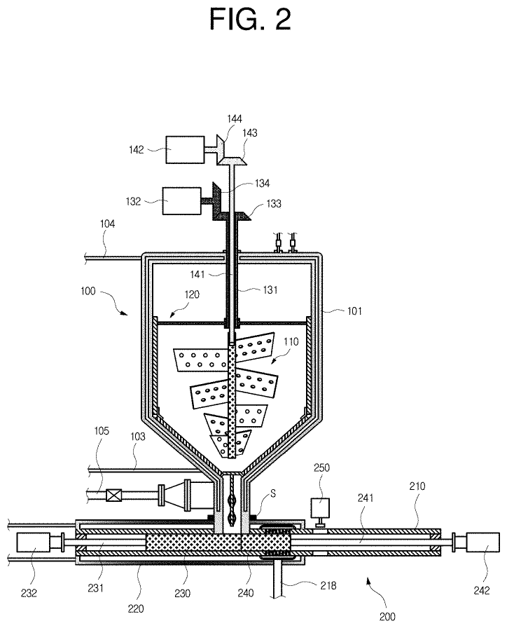

FIG. 1 is a perspective view for describing an overall configuration of a pellet manufacturing apparatus according to an embodiment of the present invention, and FIG. 2 is a cross-sectional view along section A-A of FIG. 1.

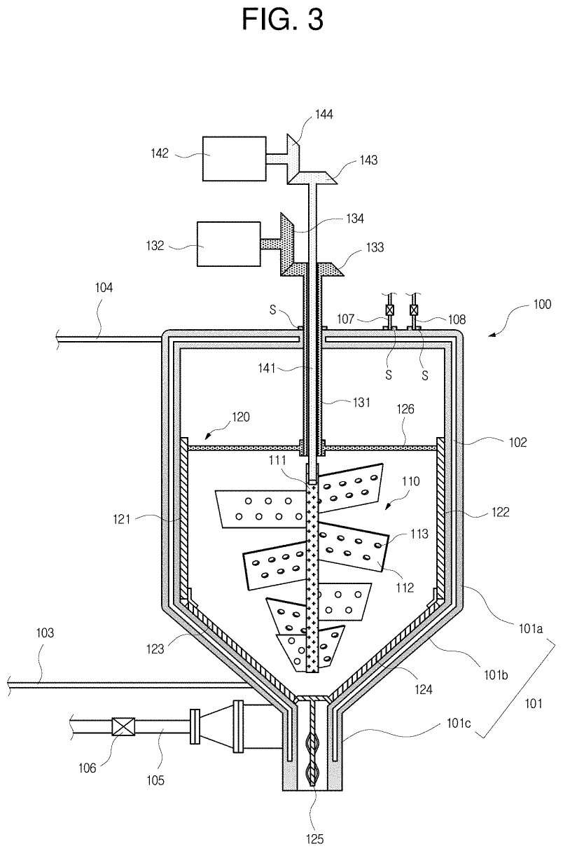

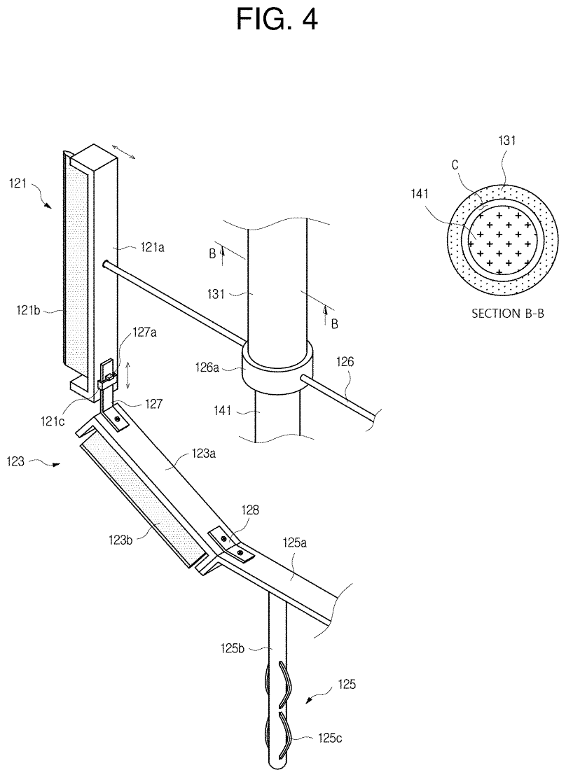

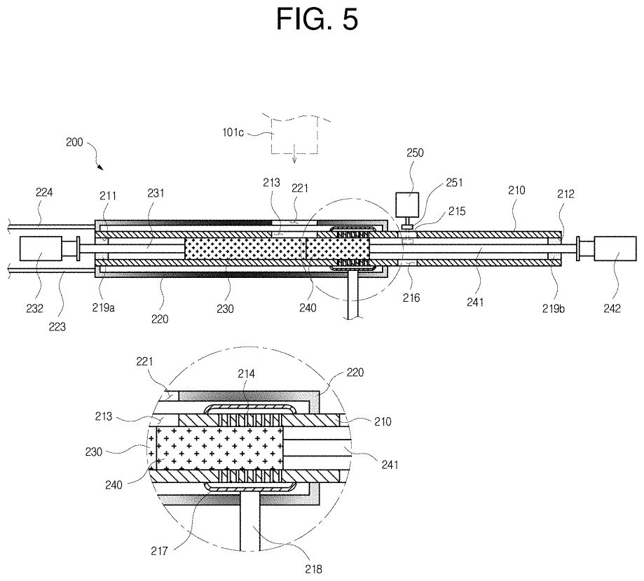

In addition, FIG. 3 is an enlarged cross-sectional view of a reactor part shown in FIG. 2, FIG. 4 is a view for describing a configuration of a scraper module shown in FIG. 2, and FIG. 5 is an enlarged cross-sectional view of a pellet forming part shown in FIG. 2.

The pellet manufacturing apparatus according to the embodiment of the present invention includes a reactor part 100 that produces and discharges slurry, a pellet forming part 200 that compresses the slurry discharged from the reactor part 100 to form the slurry in the form of pellets, and a control part 600 that controls an operation of the reactor part 100 and the pellet forming part 200.

At this time, the slurry produced in the reactor part 100 may be either gas hydrate slurry or ice slurry. In the present embodiment, for convenience of explanation, as an example of a case in which the slurry is gas hydrate slurry will be described.

To this end, the reactor part 100 includes a reactor body 101 having a reaction space in which gas hydrate is produced, a stirring module 110 installed inside the reactor body 101, and a scraper module 120 installed inside the reactor body 101.

Further, the reactor body 101 may be formed in various shapes such as a cylindrical shape or a quadrangular column shape within a range in which a gas hydrate production reaction can occur, and in the present embodiment, as an example, the reactor body 101 includes a cylindrical portion 101a, an inclined portion 101b formed to extend conically to a lower portion of the cylindrical portion (101a), and a discharge portion 101c formed to extend in a tubular shape downward from the approximate center of the inclined portion 101b.

In this case, a lower surface of the discharge portion 101c is configured to be open, and is thus configured so that the gas hydrate produced inside the reactor body 101 can be discharged to the pellet forming part 200 by gravity or a suction force of pistons 230 and 240 installed in the pellet forming part 200 as will be described below.

Further, a reaction gas supply pipe 107 and a target water supply pipe 108 that supply a reaction gas (a guest material) and target water (a host material) for producing gas hydrate are connected to one side of the reactor body 101. In the present embodiment, as an example, the reaction gas supply pipe 107 and the target water supply pipe 108 are connected to one side of an upper surface of the reactor body 101.

At this time, the reaction gas supplied through the reaction gas supply pipe 107 may be in a gas or liquid phase, in the case of the gas phase, it may be at least one of CH₄, C₂H₆, C₃H₈, CO₂, H₂, Cl₂, SF₆, a CFC-based material, an HCFC-based material, a PFC-based material, and an HFC-based material, and in the case of the liquid phase, it may be at least one of SF₆, a CFC-based material, an HCFC-based material, a PFC-based material, and an HFC-based material.

Further, the target water supplied through the target water supply pipe 108 may be, for example, wastewater or high-concentration industrial wastewater requiring removal of contaminants, seawater requiring desalination, industrial wastewater containing recoverable useful resources, and the like.

Further, the reaction gas supply pipe 107 is connected to a reaction gas supply part 650 provided outside the reactor body 101, and the target water supply pipe 108 is connected to a target water supply part 660 provided outside the reactor body 101.

Further, the reactor body 101 is configured so that the internal reaction space can maintain temperature and pressure conditions for producing gas hydrate. To this end, a temperature sensor part 610 and a pressure sensor part 620 for measuring internal temperature and pressure are installed in the reactor body 101, and a temperature adjusting part 630 and a pressure adjusting part 640 are installed to adjust the temperature and pressure inside the reactor body 101 according to the measurement results of the sensor parts 610 and 620.

In this case, the temperature adjusting part 630 may be preferably configured using a typical refrigeration cycle as an example, and the pressure adjusting part 640 may be preferably configured, for example, by controlling a supply pressure of the reaction gas.

Meanwhile, since the gas hydrate production reaction is an exothermic reaction, even when the inside of the reactor body 101 is maintained at a temperature and pressure suitable for gas hydrate production by the temperature adjusting part 630 and the pressure adjusting part 640, the internal temperature of the reactor body 101 increases as the production of gas hydrate proceeds.

Therefore, in the present embodiment, the reactor body 101 is configured in a jacket structure in which a cooling water channel 102 is formed inside a wall surface and is configured to quickly remove heat of production (or heat of reaction) of the gas hydrate by causing cooling water to flow into the cooling water channel 102 through a cooling water supply pipe 103 and a cooling water discharge pipe 104 using a cooling water supply pump 670.

In the case of the present embodiment, the cooling water channel 102 is configured as a spiral channel so that a heat transfer area can be increased, and the cooling water supply pipe 103 and the cooling water discharge pipe 104 are disposed so that the cooling water flows from a lower portion of the reactor body 101 to the upper side in consideration of the fact that more gas hydrate is produced at the lower portion side of the reactor body 101.

With such a configuration, the pellet manufacturing apparatus according to the present embodiment has an advantage that gas hydrate production efficiency and homogeneity of the produced gas hydrate are improved because it is easy to maintain a uniform and constant temperature inside the reactor body 101.

Further, with such a configuration, gas hydrate in the form of slurry is produced in the inside of the reactor body 101 by a reaction of the reaction gas and the target water, and since the content of the gas hydrate production reaction is known technology, a detailed description thereof will be omitted.

The gas hydrate slurry produced as described above is discharged through the discharge portion 101c of the reactor body 101, and the target water not used for the reaction remains in the reactor body 101 as a filtrate in which contaminants are concentrated, as will be described below.

Therefore, in the present embodiment, in order to discharge the filtrate, the reactor body 101 further includes a filtrate discharge pipe 105 connected to the lower portion (for example, the discharge portion 101c) of the reactor body 101 to discharge the filtrate to the outside, and a filtrate discharge valve 106 installed in the middle of the filtrate discharge pipe 105 to control discharge of the filtrate.

Further, the stirring module 110 and the scraper module 120 are both installed to be rotatable inside the reactor body 101. To this end, a first rotation shaft 131 for rotating the scraper module 120 and a second rotation shaft 141 for rotating the stirring module 110 are inserted into a central portion of an upper surface of the reactor body 101 in a direction perpendicular to the upper surface of the reactor body 101.

In the present embodiment, as an example, the stirring module 110 includes a third rotation shaft 111 that extends and is connected to the second rotation shaft 141, and a plurality of stirring blades 112 formed on the outer circumferential surface of the third rotation shaft 111 to be spaced apart from each other in a circumferential direction and a vertical direction.

The stirring module 110 configured as described above not only increases the efficiency of gas hydrate production by stirring the reaction gas and the target water with the stirring blades 112 while rotating inside the reactor body 101 to increase a reaction area and a reaction rate, but can also obtain an effect of uniformly producing the gas hydrate in the entire interior of the reactor body 101.

Further, a plurality of through holes 113 are formed in a surface of each of the stirring blades 112, and thus when the stirring module 110 rotates at a high speed, the reaction surface area is increased due to a cavitation phenomenon, and thus the effect of further improving the efficiency of gas hydrate production can be obtained.

Further, the scraper module 120 serves to remove the slurry attached to the inner wall surface of the reactor body 101 while rotating inside the reactor body 101. To this end, in the present embodiment, the scraper module 120 includes first and second scrapers 121 and 122 that remove the slurry attached to the inner wall surface of the cylindrical portion 101a of the reactor body, third and fourth scrapers 123 and 124 that remove the slurry attached to the inner wall surface of the inclined portion 101b of the reactor body, and a fifth scraper 125 that removes the slurry attached to the inner wall surface of the discharge portion 101c of the reactor body.

At this time, the first scraper 121 and the second scraper 122 are disposed to face each other and are connected to each other by a connecting rod 126, and a ring-shaped shaft coupling member 126a to which the first rotation shaft is coupled is formed in the center of the connecting rod 126.

Further, the first and second scrapers 121 and 122 are configured to have a movable gap in a central direction along the connecting rod, and with such a configuration, the scraper module 120 according to the present embodiment can maintain smooth rotation by the first and second scrapers 121 and 122 moving in the central direction even when a solid foreign material is attached to or an abnormal protrusion is formed on the cylindrical portion 101a of the reactor body 101.

Further, the first scraper 121 is configured of a first support bracket 121a which has a length corresponding to the cylindrical portion 101a of the reactor body 101 and of which one surface is coupled to one end of the connecting rod 126, and a first removal blade 121b which is coupled to the other surface of the first support bracket 121a to remove the slurry attached to the cylindrical portion 101a.

Further, like the first scraper 121, the second scraper 122 is also configured of a second support bracket (not shown) which has a length corresponding to the cylindrical portion 101a of the reactor body 101 and of which one surface is coupled to the other end of the connecting rod 126, and a second removal blade (not shown) which is coupled to the other surface of the second support bracket (not shown) to remove the slurry attached to the cylindrical portion 101a.

Further, the third scraper 123 is connected to a lower end of the first scraper 121 by a first connecting member 127, and the fourth scraper 124 is connected to a lower end of the second scraper 122 by a second connecting member (not shown) in the same manner as the third scraper 123.

Further, the third scraper 123 is configured of a third support bracket 123a which has an inclination and a length corresponding to the inclined portion 101b of the reactor body 101, and a third removal blade 123b which is coupled to the other surface of the third support bracket 123a to remove the slurry attached to the inclined portion 101b.

Further, the fourth scraper 124 is also configured of a fourth support bracket (not shown) which has an inclination and a length corresponding to the inclined portion 101b of the reactor body 101, and a fourth removal blade (not shown) which is coupled to the other surface of the fourth support bracket (not shown) to remove the slurry attached to the inclined portion 101b.

At this time, a first coupling ring 121c into which one end of the first connecting member 127 is inserted to be movable in a lengthwise direction of the cylindrical portion 101a is formed at a lower end of the first support bracket 121a, and a locking protrusion 127a which is caught by the first coupling ring 121c to prevent the first scraper 121 and the third scraper 123 from being separated is formed at one end of the first connecting member 127.

Meanwhile, the other end of the first connecting member 127 is fixedly coupled to one end of the third support bracket 123a, and the fourth scraper 124 is also connected to the second scraper 122 by a second connecting member (not shown) in the same manner as the third scraper 123 described above.

With the above-described configuration, since the third and fourth scrapers 123 and 124 have a movable gap in a vertical direction (that is, the lengthwise direction of the cylindrical portion), the scraper module 120 according to the present embodiment can maintain smooth rotation by the third and fourth scrapers 123 and 124 moving in the vertical direction even when a solid foreign material is attached to or an abnormal protrusion is formed on the inclined portion 101b of the reactor body 101.

Further, the fifth scraper 125 includes a panel-shaped fifth support bracket 125a of which both ends are coupled to the other ends of the third and fourth scrapers 123 and 124, a bar-shaped support rod 125b which extends from a bottom surface of the fifth support bracket 125a in the lengthwise direction of discharge portion 101c of the reactor body 101, and a plurality of fifth removal blades 125c which are attached to the outer peripheral surface of the support rod 125b.

At this time, one end of the fifth support bracket 125a is fixedly coupled to the other end of the third scraper 123 by a third connecting member 128, and the other end thereof is fixedly coupled to the other end of the fourth scraper 124 by a fourth connecting member (not shown).

With the above-described configuration, the scraper module 120 according to the present embodiment continuously removes the slurry attached to the inner wall surface of the reactor body 101 during a gas hydrate production process so that the slurry is uniformly produced inside the reactor body 101.

Meanwhile, as described above, the scraper module 120 rotates by the shaft coupling member 126a being coupled to one end of the first rotation shaft 131 inserted into the reactor body 101, and the stirring module 110 rotates by an upper end of the third rotation shaft 111 being coupled to one end of the second rotation shaft 141 inserted into the reactor body 101.

In the case of the present embodiment, the first rotation shaft 131 has a hollow rod shape, and the second rotation shaft 141 has a rod shape that is rotatably inserted into the hollow of the first rotation shaft 131, and thus the first rotation shaft 131 and the second rotation shaft 141 are configured as concentric shafts spaced apart by a gap (C).

With the above-described configuration, the reactor body 101 according to the present embodiment has an advantage that external heat transfer through the first and second rotation shafts 131 and 141 is minimized to facilitate temperature maintenance of the reactor body 101 and the gas hydrate production efficiency can be improved by minimizing a volume occupied by the first and second rotation shafts 131 and 141 inside the reactor body 101.

Further, a first driving motor 132 that rotates the first rotation shaft 131 is installed on one side of an outer portion of the reactor part 100, and a rotational force of the first driving motor 132 is transmitted to the first rotation shaft 131 by first power transmission members 133 and 134 respectively formed at the other end of the first rotation shaft 131 and an end of a rotation shaft of the first driving motor 132.

Further, a second driving motor 142 that rotates the second rotation shaft 141 is further installed on one side of the outer portion of the reactor part 100, and a rotational force of the second driving motor 142 is transmitted to the second rotation shaft 141 by second power transmission members 143 and 144 respectively formed at the other end of the second rotation shaft 141 and an end of a rotation shaft of the second driving motor 142.

In this case, each of the first power transmission members 133 and 134 and the second power transmission members 143 and 144 may be preferably implemented by a typical power transmission gear structure or belt-pulley structure.

Further, more preferably, a sealing member (S) for airtight maintenance is interposed in connection portions of the reaction gas supply pipe 107 and the target water supply pipe 108 and insertion portions of the first and second rotation shafts 131 and 141.

Meanwhile, the pellet forming part 200 includes a first pipe 210 having a first through hole 213 formed at one side of an outer surface thereof to be connected to the discharge portion 101c of the reactor part 100, a compression forming module which compresses the slurry supplied into the first pipe 210 through the first through hole 213 to form the slurry into pellets, and a heating module which is installed on one side of the first pipe 210 to heat the inside of the first pipe 210.

Further, the first pipe 210 has a pipe shape in which first and second ends 211 and 212, which are both ends, are open, and the first through hole 213 is formed in the middle of the first pipe 210.

Further, a plurality of dewatering holes 214 and an opening 215 through which a cylinder rod 251 of a push cylinder 250 for pushing and discharging the formed pellets enters or exits, as will be described below, are sequentially formed at positions spaced apart from the first through hole 213 in an outer surface of the first pipe 210 in the lengthwise direction of the first pipe 210.

Further, a pellet discharge hole 216 through which the pellets are discharged is further formed at a position facing the opening 215 in the outer surface of the first pipe 210.

Further, the compression forming module includes a piston installed inside the first pipe 210 and a driving cylinder which moves the piston in the lengthwise direction of the first pipe 210.

To this end, in the present embodiment, as an example, the piston includes a first piston 230 and a second piston 240, and the driving cylinder includes a first driving cylinder 232 installed outside the first end 211 of the first pipe 210 to move the first piston 230, and a second driving cylinder 242 installed outside the second end 212 of the first pipe 210 to move the second piston 240.

At this time, the first piston 230 is connected to the first driving cylinder 232 by a first cylinder rod 231, and the second piston 240 is connected to the second driving cylinder 242 by a second cylinder rod 241.

Further, the first and second ends 211 and 212 of the first pipe 210, which are open, are sealed by a first hermetic member 219a and a second hermetic member 219b, and the first and second driving cylinders 232 and 242 are installed outside both ends of the first pipe 210 so that the cylinder rods 231 and 241 can advance and retreat through central portions of the first hermetic member 219a and the second hermetic member 219b.

Further, each of the first and second driving cylinders 232 and 242 may be preferably implemented using a typical electric cylinder or hydraulic cylinder, and in the present embodiment, as will be described below, when the slurry is compressed and formed into pellets, it is characterized in that it is configured of a servo motor cylinder using a servo motor for easy torque control in order to accurately control a compression force.

Further, in the present embodiment, as an example, a case in which the compression forming module is configured of a pair of pistons moved by a dual cylinder has been described, but the present invention is not limited thereto and may be configured in several different ways within the scope of performing the same function.

Specifically, as another modified example of the compression forming module according to the present embodiment, the first piston 230 moved by a first driving cylinder 232 is installed at the first end 211 of the first pipe 210, and the second end 212 may include an opening and closing member (not shown) which closes the second end of the first pipe when the slurry is compressed and opens the second end of the first pipe when the pellets are discharged.

Meanwhile, the heating module may be configured of a heating wire or the like surrounding the outer surface of the first pipe, and in the present embodiment, as an example, the heating module includes a second pipe 220 in which the heating module wraps the outer surface of the first pipe 210 in a jacket structure, and a heating medium supply module which causes a heating medium to flow in a space formed between the outer surface of the first pipe 210 and the inner surface of the second pipe 220.

Further, in the second pipe 220, a second through hole 221 through which the discharge portion 101c of the reactor part 100 passes is formed at one side of the outer surface thereof at a position corresponding to the first through hole 213, and both ends are sealingly coupled to the outer surface of the first pipe 210 to form a closed space, in which the heating medium flows, between the outer surface of the first pipe 210 and the inner surface of the second pipe 220.

Further, the heating medium supply module includes a heating medium supply pipe 223 which supplies a heating medium to a heating medium flow space (not shown) that is a space formed between the first pipe 210 and the second pipe 220, a heating medium discharge pipe 224 which discharges the heating medium in the heating medium flow space (not shown), and a heating medium supply pump 680 which causes the heating medium to flow into the heating medium flow space (not shown) through the heating medium supply pipe 223 and the heating medium discharge pipe 224.

At this time, the second pipe 220 is preferably installed to surround the outer surface of the first pipe 210 corresponding to the inner space of the first pipe 210 in which suction and compression of the slurry (that is, forming of pellets) occur.

To this end, in the present embodiment, as an example, the first through hole 213 and the dewatering hole 214 are formed in the outer surface of the first pipe 210 included in the heating medium flow space (not shown) formed by the second pipe 220, and the opening 215 and the pellet discharge hole 216 are configured to be formed in the outer surface of the first pipe 210 located outside the heating medium flow space (not shown).

Further, more preferably, a sealing member S for airtight maintenance is interposed in the coupling portion between the discharge portion 101c of the reactor part 100 and the second through hole 221.

Further, the pellet forming part 200 further includes a third pipe 217 which is interposed between the first pipe 210 and the second pipe 220 and surrounds the outer surface of the first pipe 210 in a jacket structure to cover the dewatering hole 214, and a drain tube 218 which is connected to the third pipe 217.

At this time, the drain tube 218 discharges the filtrate discharged to the third pipe 217 through the dewatering hole 214 during the compression of the slurry to the outside as needed or re-supplies the filtrate to the reactor part 100 as will be described below.

Further, the pellet forming part 200 further includes a push cylinder 250 installed on one side of an outer portion of the first pipe 210, and the push cylinder 250 performs a function of discharging the pellets through the pellet discharge hole 216 by pushing the pellets that are moved to a position at which the pellet discharge hole 216 is formed due to the cylinder rod 251 entering and exiting through the opening 215, as will be described below.

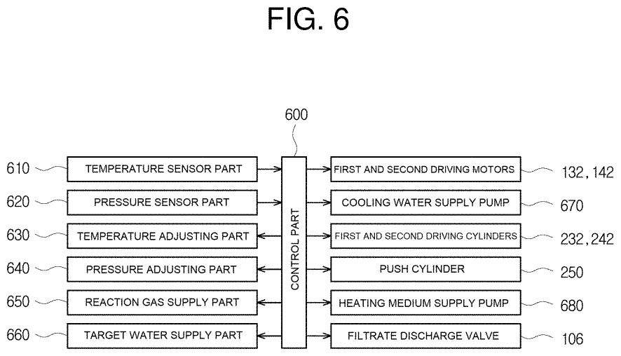

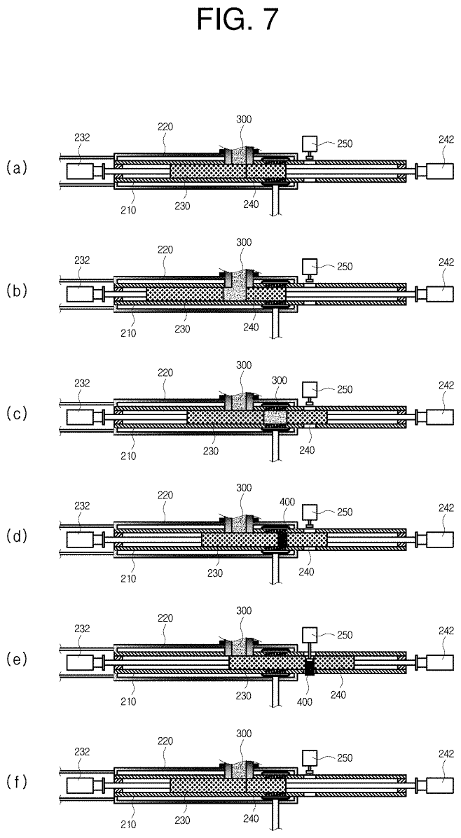

Hereinafter, a pellet manufacturing method using the pellet manufacturing apparatus according to the embodiment of the present invention described above using FIGS. 6 and 7 will be described in detail.

FIG. 6 is a block diagram for describing an operation configuration of the apparatus of FIG. 1, and FIG. 7 is a process diagram for describing the pellet manufacturing method with the apparatus of FIG. 1.

First, the control part 600 according to the present embodiment controls the temperature adjusting part 630 and the pressure adjusting part 640 according to the measurement results of the temperature sensor part 610 and the pressure sensor part 620 for measuring the temperature and pressure inside the reactor body 101, and thus the inside of the reactor body 101 is adjusted so that the temperature and pressure suitable for the production of gas hydrate are maintained.

Further, the control part 600 controls the reaction gas supply part 650 and the target water supply part 660 to supply the reaction gas and target water for producing gas hydrate into the reactor body 101, and controls the first and second driving motors 132 and 142 to operate the stirring module 110 and the scraper module 120 and to produce gas hydrate inside the reactor body 101.

In this case, as the gas hydrate production reaction proceeds, the control part 600 operates the cooling water supply pump 670 to cause cooling water to flow through the cooling water channel 102, thereby removing the reaction heat of the gas hydrate.

Further, when the gas hydrate slurry is produced to some extent in the reactor body 101, the control part 600 controls operations of the first and second driving cylinders 232 and 242 and the push cylinder 250 to compress the slurry supplied from the reactor body 101 into the first pipe 210, to form the slurry into pellets, and then to discharges the pellets.

Further, the control part 600 maintains the internal temperature of the first pipe, in which the pellets are formed, in a predetermined temperature range by supplying a heating medium to the space formed between the outer surface of the first pipe 210 and the inner surface of the second pipe 220 using the heating medium supply pump 680 when the pellets are formed, and the temperature range is preferably determined to include a temperature at which surfaces of the formed pellets can be melted and contaminants (or useful resources) attached to the surfaces of the pellets can be discharged as a filtrate.

Further, if necessary, the control part 600 opens the filtrate discharge valve 106 installed in the middle of the filtrate discharge pipe 105 to discharge the filtrate inside the reactor body 101 to the outside.

Next, the pellet manufacturing method using the pellet manufacturing apparatus according to the present embodiment will be described. The control part 600 produces the pellets by performing a first step of producing gas hydrate slurry in the reactor body 101, a second step of supplying the produced slurry into the first pipe 210 installed on one side of the outer portion of the reactor body 101, and a third step of compressing the slurry inside the first pipe 210 and forming the slurry into pellets, and hereinafter, for convenience of explanation, the second and third steps will be mainly described.

When the gas hydrate slurry is produced in the reactor body 101, the control part 600 arranges the ends of the first piston 230 and the second piston 240 at an initial position at which the first through hole 213 of the first pipe 210 is formed, and in this case, as an example, the first piston 230 and the second piston 240 may be arranged so that upper surfaces thereof are in contact with each other (refer to step (a) of FIG. 7).

When the step (a) of FIG. 7 is completed, the control part 600 supplies the slurry 300 produced in the first step to a space between the first piston 230 and the second piston 240 through the first through hole 213 by moving at least one of the first piston 230 and the second piston 240 a predetermined distance away from the other in the lengthwise direction of the first pipe 210 (refer to step (b) of FIG. 7).

In this case, the control part 600 moves at least one of the first and second pistons 230 and 240 according to the positions at which the ends of the first and second pistons 230 and 240 are arranged, and preferably moves the first piston 230 in the case of FIG. 7.

The pellet manufacturing method according to the present embodiment, as described above, has an advantage that, since a constant separation distance between the first and second pistons 230 and 240 is always controlled so that the slurry 300 is supplied (or suctioned), even when the pellets are repeatedly manufactured in a continuous process, an amount of the supplied slurry 300 is always constant, and thus pellets of a uniform mass can be manufactured.

Further, in the steps (a) and (b) of FIG. 7 described above, as an example, the method in which the slurry 300 is suctioned by a pressure difference due to movement of the pistons 230 and 240 has been described, but if necessary, after the first and second pistons 230 and 240 are arranged to be spaced apart from each other at the initial position, the slurry may be supplied to the space between the first and second pistons 230 and 240 by gravity.

When the step (b) of FIG. 7 is completed, the control part 600 moves the slurry 300 supplied in the step (b) of FIG. 7 to a position at which the dewatering hole 214 is formed by moving the first piston 230 and the second piston 240 in the same direction along the lengthwise direction of the first pipe 210 (refer to step (c) of FIG. 7).

When the step (c) of FIG. 7 is completed, the control part 600 compresses the slurry 300 and forms the slurry 300 into pellets 400 by moving the first piston 230 and the second piston 240 closer to each other in the lengthwise direction of the first pipe 210 (refer to step (d) of FIG. 7).

In this case, the filtrate discharged through the dewatering hole 214 in a compression process of the slurry 300 (that is, a pellet forming process) may be discharged to the outside through the third pipe 217 and the drain tube 218 or may be re-supplied to the reactor part 100 as the target water.

Further, in the case of the present embodiment, in the step (d) of FIG. 7, the control part 600 controls the servo motor torques of the first driving cylinder 232 and the second driving cylinder 242 to compress the slurry 300 with a predetermined compression force.

With such a configuration, the pellet manufacturing method according to the present embodiment can produce pellets having uniform hardness even when the pellets are repeatedly manufactured in a continuous process, and as described above, when the quantitative suction of the slurry is performed, there is an advantage that a thickness of each of the pellets can be uniformly manufactured.

Further, when the step (d) of FIG. 7 (that is, the step of forming the pellets) is performed, the control part 600 controls the operation of the heating module so that the internal temperature of the first pipe 210 is adjusted to a predetermined temperature range.

As in the present embodiment, when the heating module is configured of a heating medium supply module, the control part 600 controls at least one of a temperature of the heating medium or a flow amount of the heating medium to adjust the internal temperature of the first pipe 210.

At this time, the temperature range is preferably determined to include a temperature at which the surfaces of the pellets formed as described above can be melted by a certain amount and the contaminants (or useful resources) attached to the surfaces of the pellets can be discharged as a filtrate.

In the case of the pellet manufacturing apparatus and manufacturing method according to the present embodiment, since the internal temperature of the first pipe 210 is increased by the heating medium supply module to melt the surfaces of the pellets 400 in a certain amount when the pellets are formed and thus the contaminants attached to the surfaces of the pellets 400 are discharged as a filtrate, there is an advantage that high-purity pellets can be manufactured when compared to an existing gas hydrate pellet producing apparatus.

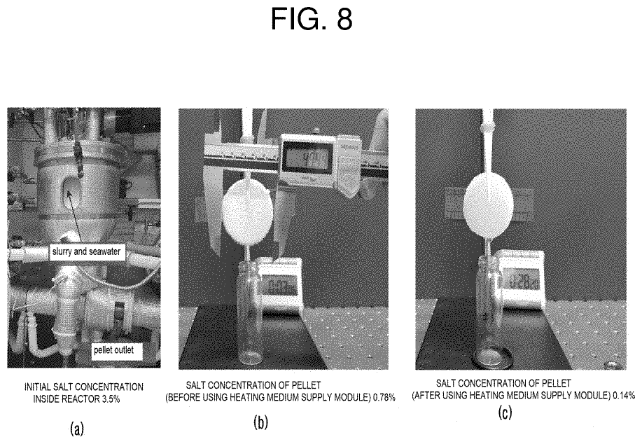

FIG. 8 is a view showing results of performing a test for comparing purity of pellets formed without the heating medium supply module (refer to FIG. 8B) and pellets formed with the heating medium supply module (refer to FIG. 8C) by using the pellet manufacturing apparatus (refer to FIG. 8A) according to the present embodiment.

An initial salt concentration of the target water supplied to the reactor was 3.5%, a salt concentration of pellets formed without the heating medium supply module was 0.78%, and the salt concentration of the pellets formed with the heating medium supply module was 0.14%, and it was measured that when the heating medium supply module was used, about 10% of the pellet surface was melted and discharged as a filtrate.

As a result of the above test, in the case of the pellets using the heating medium supply module, a salt removal rate was found to be very high at about 96%, and it was experimentally confirmed that the salt removal rate was improved by about 15% or more compared to the pellets without using the heating medium supply module.

Meanwhile, when the step (d) of FIG. 7 is completed, the control part 600 moves the fully formed pellets 400 to the position at which the opening 215 and the pellet discharge hole 216 are formed by moving the first piston 230 and the second piston 240 in the same direction along the lengthwise direction of the first pipe 210 and then discharges the pellets 400 to the outside of the first pipe 210 through the pellet discharge hole 216 using the push cylinder 250 (refer to step (e) of FIG. 7).

When the step (e) of FIG. 7 is completed, the control part 600 continuously manufactures the pellets by arranging the ends of the first and second pistons 230 and 240 in the same initial positions as in the step (a) of FIG. 7 and then repeatedly performing the steps (b) to (f) of FIG. 7 (refer to step (f) of FIG. 7).

In the case of the pellet manufacturing apparatus and manufacturing method according to the present embodiment described above in detail, since the reactor part 100 and the pellet forming part 200 are spatially separated, there is an advantage that the temperature and pressure inside the reactor part 100 can be easily maintained and thus the gas hydrate production efficiency can be improved.

Further, in the pellet manufacturing apparatus and manufacturing method according to the present embodiment, since the internal temperature of the pellet forming part (specifically, the first pipe) can be independently controlled by the heating medium supply module, there is an advantage that high purity pellets can be manufactured by melting a certain amount of the pellet surface during the forming of the pellets and discharging the contaminants attached to the pellet surface as a filtrate.

Further, since the pellet manufacturing apparatus and manufacturing method according to the present embodiment are configured to perform quantitative suction and constant torque compression of the slurry by the cylinder operated by the servo motor in the pellet forming part, there is an advantage in that pellets always having a uniform thickness and/or hardness can be manufactured even when the pellets are repeatedly manufactured by a continuous process.

Further, the pellet manufacturing apparatus and manufacturing method according to the embodiment of the present invention described above is applicable to a water treatment for high concentration industrial wastewater or brine because the salt removal efficiency is very excellent as confirmed through tests.

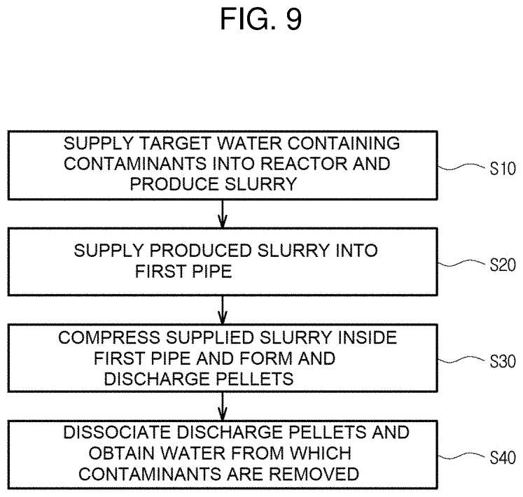

In this case, as an example shown in FIG. 9, the water treatment method using the pellet manufacturing apparatus includes a step S10 of supplying the target water containing contaminants to the reactor part 100 and producing slurry, a step S20 of supplying the produced slurry into the first pipe 210, a step S30 of compressing the supplied slurry inside the first pipe 210 and forming the slurry into pellets, and a step S40 of dissociating the discharged pellets to obtain water from which the contaminants are removed.

In this case, steps S10 to S30 are the same as in the pellet manufacturing method described above and step S40 can be preferably configured using any one of the known gas hydrate dissociation devices, and thus, here, a detailed description of each step will be omitted.

However, when the slurry produced in step S10 is ice slurry, step S40 preferably includes a step of obtaining water from which contaminants are removed by heating and melting the pellets discharged in step S30.

Further, in the case of such a water treatment method for a wastewater treatment, the filtrate discharged in step S30 is discharged to the outside for a water treatment by a continuous process.

Meanwhile, the pellet manufacturing apparatus and manufacturing method according to the embodiment of the present invention are applicable to a water treatment for recovering useful resources from the target water.

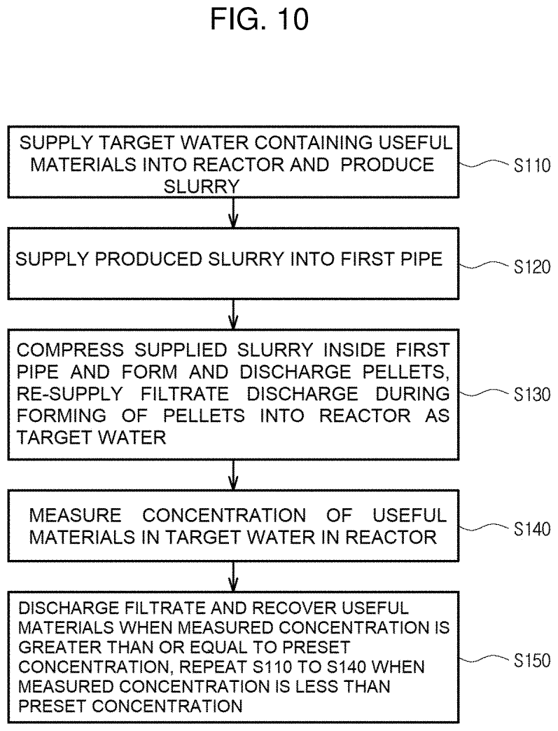

Specifically, as shown in FIG. 10, the water treatment method includes a step S110 of supplying the target water containing useful resources to the reactor part 100 and producing slurry, a step S120 of supplying the produced slurry into the first pipe 210, a step S130 of compressing the supplied slurry inside the first pipe 210 to form the slurry into pellets and to discharge the pellets, and re-supplying a filtrate discharged during forming of the pellets to the reactor part 100 as target water, a step S140 of measuring a concentration of useful resources contained in the target water in the reactor part 100, and a step S150 of discharging the filtrate to recover the useful resources when the measured concentration is greater than or equal to a preset concentration and repeating steps S110 and S140 when the measured concentration is less than the preset concentration.

In this case, since steps S110 and S120 are the same as in the pellet manufacturing method described above, a detailed description of the steps will be omitted here.

Meanwhile, step S130 is different from the water treatment method for a wastewater treatment described above in that the concentration of the filtrate (that is, the concentration of useful resources) is made by re-supplying the filtrate discharged in the pellet forming step to the reactor part 100 as the target water.

In addition, the recovery of the useful resources may be preferably implemented by any known method such as adsorption of useful resources using a chemical reaction, physical precipitation, or a dedicated filter.

### INDUSTRIAL APPLICABILITY

The present invention can be applied to the fields of hydrate production and storage, treatment of high-concentration contaminated water, or recovery of useful resources from wastewater.

1. A pellet manufacturing apparatus comprising:
a reactor part configured to produce and discharge slurry that is either gas hydrate slurry or ice slurry;
a pellet forming part installed on one side of an outer portion of the reactor part and configured to compress the slurry discharged from the reactor part and to form the slurry into pellets; and
a control part configured to control an operation of the reactor part and the pellet forming part,
wherein the pellet forming part includes a first pipe having a through hole formed at one side of an outer surface thereof to be connected to an outlet of the reactor part, a compression forming module configured to compress the slurry supplied into the first pipe through the through hole and to form the slurry into pellets, and a heating module installed on one side of the first pipe to heat an inside of the first pipe,
the heating module include, a second pipe having a second through hole formed on one side of an outer surface at a position corresponding to the first through hole and configured to surround an outer surface of the first pipe in a jacket structure, and a heating medium supply module configured to cause a heating medium to flow to a space formed between the outer surface of the first pipe and an inner surface of the second pipe,
the pellet forming a further include a third pipe interposed between the first pipe and the second pipe and configured to surround the outer surface of the first pipe in a jacket structure it cover a dewatering hole, and a drain tube connected to the third pipe, and
the control part controls an operation of the heating module so that an internal temperature of the first pipe is adjusted to a predetermined temperature range when the pellets are formed.

2. The pellet manufacturing apparatus of claim 1
when the pellets are formed, the control part controls at least any one of a temperature of the heating medium or a flow amount of the heating medium to adjust the internal temperature of the first pipe.

3. The pellet manufacturing apparatus of claim 1, wherein the compression forming module includes a piston installed inside the first pipe and a driving cylinder configured to move the piston in a lengthwise direction of the first pipe.

4. The pellet manufacturing apparatus of claim 3, wherein the piston is configured of a first piston and a second piston, and
the driving cylinder is configured of a first driving cylinder installed at one end of the first pipe to move the first piston, and a second driving cylinder installed at the other end of the first pipe to move the second piston.

5. The pellet manufacturing apparatus of claim 4, wherein the control part moves at least one of the first piston and the second piston a predetermined distance away from the other in a state in which ends of the first and second pistons are arranged at a position at which a through hole of the first pipe is formed, so that the slurry discharged from the reactor part is supplied to a space between the first and second pistons.

6. The pellet manufacturing apparatus of claim 4, wherein the slurry is supplied to a space between the first piston and the second piston, and
the control part controls an operation of the first and second driving cylinders to compress the slurry by moving the first and second pistons closer to each other when the pellets are formed.

7. The pellet manufacturing apparatus of claim 6, wherein the first driving cylinder and the second driving cylinder are servomotor cylinders, and
the control part compresses the slurry with a predetermined compressive force by controlling servomotor torque of the first and second driving cylinders when the pellets are formed.

8. The pellet manufacturing apparatus of claim 4, wherein a plurality of dewatering holes are further formed at a position spaced apart from the first through hole in the outer surface of the first pipe,
the slurry is supplied to a space between the first piston and the second piston, and
the control part controls an operation of the first and second driving cylinders to move the slurry to a position at which the dewatering holes are formed and then to compress the slurry when the pellets are formed.

9. (canceled)

10. The pellet manufacturing apparatus of claim 8, wherein the pellet forming part further includes a push cylinder installed on one side of an outer portion of the first pipe,
an opening through which a cylinder rod of the push cylinder enters or exits and a pellet discharge hole configured to face the opening are further formed at positions spaced apart from the first through hole and the dewatering holes in the outer surface of the first pipe, and
when forming of the pellets is completed, the control part controls operations of the first driving cylinder, the second driving cylinder, and the push cylinder to move the pellets to the position at which the opening and the pellet discharge hole are formed and then to discharge the pellets to the outside of the first pipe through the pellet discharge hole.

11. A pellet manufacturing method using the pellet manufacturing, apparatus of claim 1, comprising:
a first step of producing slurry that is either gas hydrate slurry or ice slurry in the reactor;
a second step of supplying the slurry produced in the first step into the first pipe installed on one side of an outer portion of the reactor; and
a third step of compressing the slurry supplied in the second step inside the first pipe and forming the slurry into pellets,
wherein, in the third step, an internal temperature of the first pipe is adjusted to a predetermined temperature range when the pellets are formed.

12. The pellet manufacturing method of claim 11, wherein, in the third step, when the pellets are formed, a heating medium flows in a space formed between an inner surface of a second pipe that surrounds an outer surface of a first pipe in a jacket structure and the outer surface of the first pipe, and at least one of a temperature of the heating medium or a flow amount of the heating medium is controlled to adjust the internal temperature of the first pipe.

13. The pellet manufacturing method of claim 11,
wherein a through hole through which the slurry is supplied is formed in the outer surface of the first pipe, and
the second step includes a step 2-1 of arranging ends of first and second pistons installed inside the first pipe at a position at which the through hole is formed, and a step 2-2 of moving at least one of a first piston and a second piston a predetermined distance away from the other in a lengthwise direction of the first pipe and thus supplying the slurry produced in the first step to a space between the first piston and the second piston through the through hole.

14. The pellet manufacturing method of claim 11, wherein, in the second step, the slurry produced in the first step is supplied to a space between a first piston and a second piston installed inside the first pipe, and
in the third step, the slurry is compressed by moving the first piston and the second piston closer to each other in a lengthwise direction of the first pipe when the pellets are formed.

15. The pellet manufacturing method of claim 14, wherein the first piston and the second piston are moved by servomotor cylinders, and
in the third step, servomotor torques of the servomotor cylinders are controlled to compress the slurry with a predetermined compression force when the pellets are formed.

16. The pellet manufacturing method of claim 11, wherein a through hole through which the slurry is supplied and a dewatering hole through which a filtrate is discharged when the pellet is formed are formed in an outer surface of the first pipe to be spaced apart from each other,
in the second step, the slurry produced in the first step is supplied to a space between the first piston and the second piston installed inside the first pipe through the through hole, and
the third step includes a step 3-1 of moving the first piston and the second piston in the same direction along a lengthwise direction of the first pipe and thus moving the slurry supplied in the second step to a position at which the dewatering hole is formed, and a step 3-2 of moving the first piston and the second piston closer to each other in the lengthwise direction of the first pipe and compressing the slurry to form the slurry into pellets.

17. The pellet manufacturing method of claim 16, further comprising a fourth step of moving the pellets formed in the third step to a position of the pellet discharge hole formed in the outer surface of the first pipe and then discharging the pellets to the outside through the pellet discharge hole.

18. A water treatment method of treating target water that is high concentration wastewater or brine using the pellet manufacturing apparatus if claim the method comprising:
a first step of supplying target water containing contaminants to the reactor and producing slurry that is either gas hydrate slurry or ice slurry;
a second step of supplying the slurry produced in the first step into the first pipe installed on one side of an outer portion of the reactor;
a third step of compressing the slurry supplied in the second step inside the first pipe to form the slurry into pellets and discharging the pellets; and
a fourth step of dissociating or melding the pellets discharged in the third step and obtaining water from which the contaminants are removed,
wherein, in the third step, an internal temperature of the first pipe is adjusted to a predetermined temperature range when the pellets are formed.

19. The water treatment method of claim 18, wherein, in the third step, when the pellets are formed, a heating medium flows in a space formed between an inner surface of a second pipe that surrounds an outer surface of a first pipe in a jacket structure and the outer surface of the first pipe, and at least one of a temperature of the heating medium or a flow amount of the heating medium is controlled to adjust the internal temperature of the first pipe.

20. The water treatment method of claim 18, wherein a through hole through which the slurry is supplied is formed in the outer surface of the first pipe, and
the second step includes a step 2-1 of arranging ends of first and second pistons installed inside the first pipe at a position at which the through hole is formed, a step 2-2 of moving at least one of a first piston and a second piston a predetermined distance away from the other in a lengthwise direction of the first pipe and thus supplying the slurry produced in the first step to a space between the first piston and the second piston through the through hole.

21. The water treatment method of claim 18, wherein, in the second step, the slurry produced in the first step is supplied to a space between a first piston and a second piston installed inside the first pipe, and
in the third step, the slurry is compressed by moving the first piston and the second piston closer to each other in a lengthwise direction of the first pipe when the pellets are formed.

22. The water treatment method of claim 21, wherein the first piston and the second piston are moved by servomotor cylinders, and
in the third step, servomotor torques of the servomotor cylinders are controlled to compress the slurry with a predetermined compression force when the pellets are formed.

23. The water treatment method of claim 18, wherein a through hole through which the slurry is supplied and a dewatering hole through which a filtrate is discharged when the pellet is formed are formed in an outer surface of the first pipe to be spaced apart from each other,
in the second step, the slurry produced in the first step is supplied to a space between the first piston and the second piston installed inside the first pipe through the through hole, and
the third step includes a step 3-1 of moving the first piston and the second piston in the same direction along a lengthwise direction of the first pipe and thus moving the slurry supplied in the second step to a position at which the dewatering hole is formed, and a step 3-2 of moving the first piston and the second piston closer to each other in the lengthwise direction of the first pipe and compressing the slurry to form the slurry into pellets.

24. The water treatment method of claim 18, wherein, in the third step, the temperature range is determined to include a temperature at which surfaces of the formed pellets are melted and contaminants attached to the surfaces of the pellets are discharged as a filtrate.

25. (canceled)

26. (canceled)

27. (canceled)
